(19) United States
(12) Patent Application Publication
(10) Pub. No.: US 2009/0027620 A1
(43) Pub. Date: Jan. 29, 2009

(54) PORTABLE MULTIMEDIA PROJECTION DEVICE

(75) Inventors: Ching-Hua LIN, Hsinchu City (TW); Wen-Hsing CHANG, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: MUSTEK TECHNOLOGY CO. LTD., Hsinchu City (TW)

(21) Appl. No.: 11/935,206

(22) Filed: Nov. 5, 2007

(30) Foreign Application Priority Data
Jul. 24, 2007 (TW) 96212115

(51) Int. Cl. G03B 21/10; G03B 21/14

(52) U.S. Cl. 353/15; 353/43; 353/79

(57) ABSTRACT

A portable multimedia projection device is provided for showing the multimedia information for a plurality of audiences and promoting the sharing quality of the multimedia information. The portable multimedia projection device includes a data storage unit, an image projecting unit, a control circuit, and an independent power. The data storage unit is disposed to store a multimedia data, the image projecting unit is electrically connected to the data storage unit, and disposed to project the multimedia data, the control circuit is electrically connected to the data storage unit and the image projecting unit and disposed to control the operating, transmitting, and broadcasting of the multimedia data, and the independent power is disposed to provide the electric power the portable multimedia projection device needs to operate.

### FIELD OF THE INVENTION

The present invention relates to a portable multimedia display device, and more particularly to a portable multimedia projection device.

### BACKGROUND OF THE INVENTION

In the recent years, the requirement for displaying and sharing an image has increased with the progress and popularization of information and image technology. Furthermore, the information products have become more movable, individualized, and portable since people often moves in the modern life, such as the portable DVD player, Personal TV, portable digital image storage device for the photographers, Portable Media Player (PMP), and etc.

Most of the above-mentioned current products are configured to be of small size and with light LCD panels so as to be carried easily while the users are moving. However, the small sized LCD panels are hardly to be watched and shared by a plurality of users, so that the application qualities thereof are limited.

From the above description, in order to overcome the drawbacks in the prior art, a portable multimedia projection device is provided by the inventor via the devoting research and perseverant work.

### SUMMARY OF THE INVENTION

In accordance with one aspect of the present invention, a portable multimedia projection device is provided to increase the number of the audiences and to promote the sharing quality of the multimedia information.

In accordance with another aspect of the present invention, a portable multimedia projection device is provided. The device includes a data storage unit, an image projecting unit, a control circuit, an independent power source and a projection screen, wherein the data storage unit is configured for storing a multimedia data; the image projecting unit is electrically connected to the data storage unit for projecting the multimedia data; the control circuit is electrically connected to the data storage unit and the image projecting unit for controlling operating, transmitting and broadcasting of the multimedia data; the independent power source provides an electric power to the portable multimedia display equipment; the projection screen is connected to a case for displaying an image projected from the image projecting unit; wherein at least one of the data storage unit, the image projecting unit, the control circuit and the independent power source is housed in the case.

Preferably, the projection screen further includes a curtain, a reel, an extendable frame and a fastener, wherein the curtain is configured for displaying an image; the reel is configured for rolling up the curtain; the extendable frame is configured for supporting the curtain, and the fastener is configured for fastening the curtain with the extendable frame while the curtain is opened.

Preferably, the extendable frame further includes a first stick having the fastener thereon for fastening the curtain, and a second stick connected to the case and the first stick.

Preferably, the portable multimedia projection device further includes a sound broadcasting unit having a loudspeaker, wherein the sound broadcasting unit is electrically connected to the control circuit for broadcasting a sound signal of the multimedia data.

Preferably, the data storage unit further includes a data transmission interface for transmitting and receiving a data.

Preferably, the data storage unit is one selected from a group consisting of a hard disk, a CD-ROM, a flash memory a memory card and a combination thereof and the data transmission interface is one selected from a group consisting of a USB, a CD-RW reader, a memory card reader an IrDA, a bluetooth, a network interface card an antenna and a combination thereof.

Preferably, the image projecting unit has a light source.

Preferably, the light source is an LED and the independent power source is a battery.

Preferably, the portable multimedia projection device further includes a power link interface, through which an exterior power source provides a electric power to the portable multimedia projection device.

Preferably, the portable multimedia projection device further includes a user operation interface electrically connected to the control circuit for inputting a control command to the portable multimedia projection device and displaying an operation status of the portable multimedia projection device.

In accordance with another aspect of the present invention, a portable multimedia projection device is provided. The portable multimedia projection device includes a data storage unit, an image projecting unit, a control circuit and an independent power, wherein the data storage unit is configured for storing a multimedia data; the image projecting unit is electrically connected to the data storage unit for projecting the multimedia data; the control circuit is electrically connected to the data storage unit and the image projecting unit for controlling operating, transmitting and broadcasting of the multimedia data, and the independent power source provides an electric power to the portable multimedia projection device.

Preferably, the portable multimedia projection device further includes a case and a projection screen, wherein the case houses at least one of the data storage unit, the image projecting unit, the control circuit and the independent power source; and the projection screen is detachably connected to the case and displays an image projected from the image projecting unit.

Preferably, the projection screen further includes a first screen connected with the case via a first pivot, and the first screen rotates with the first pivot.

Preferably, the projection screen further includes at least one second screen connected with the first screen via a second pivot, and the second screen is capable of being opened and folded in a specific angle.

In accordance with another aspect of the present invention, a portable multimedia projection device is provided. The portable multimedia projection device includes a data transmission interface, an image projecting unit and an independent power source, wherein the data transmission interface transfers a multimedia data; the image projecting unit is electrically connected to the data transmission interface and provided with a light for projecting an image of the multimedia data, and the independent power source provides the electric power to the portable multimedia projection device.

Preferably, the portable multimedia projection device further includes a case and a projection screen, wherein the projection screen is detachably connected with the case for displaying the image projected from the image projecting unit, and at least one of the data storage unit, the image projecting unit, the projection screen and the independent power source is contained in the case.

Preferably, the projection screen further includes a curtain, a reel and an extendable frame, wherein the curtain displays an image; the reel is configured for rolling up the curtain, and the extendable frame is connected with the case for supporting the curtain, and the extendable frame further includes a first brace connected with the case and the reel for supporting the reel, and a second brace having a plurality of linkages for supporting the curtain.

Preferably, the projection screen further includes a first screen connected with the case via a first pivot, and the first screen rotates with the first pivot.

Preferably, the projection screen further includes at least one second screen connected with the first screen via a second pivot, and the second screen is capable of being opened and folded in a specific angle.

Preferably, the portable multimedia projection device further includes a data storage unit, a sound broadcasting unit, a user operation interface and a control circuit, wherein the data storage unit is electrically connected to the data transmission interface for storing the multimedia data; the sound broadcasting unit is electrically connected to the data transmission interface for broadcasting a sound signal of the multimedia data; the user operation interface is configured for inputting a control command to the portable multimedia projection device and displaying an operation status of the portable multimedia projection device; and the control circuit is electrically connected to the data transmission interface, the data storage unit, the image projecting unit, the sound broadcasting unit and the user operation interface so as to control operating, transmitting and broadcasting of the multimedia data.

The above objects and advantages of the present invention will become more readily apparently to those ordinarily skilled in the art after reviewing the following detailed descriptions and accompanying drawings, in which:

### BRIEF DESCRIPTION OF THE DRAWINGS

FIG. 1 is a schematic diagram showing the portable multimedia projection device of the present invention according to the first embodiment of the present invention.

FIG. 2 is a schematic diagram showing the portable multimedia projection device of the present invention according to the second embodiment of the present invention.

FIG. 3 is a schematic diagram showing the portable multimedia projection device of the present invention according to the third embodiment of the present invention.

FIG. 4 is a schematic diagram showing the portable multimedia projection device of the present invention according to the fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

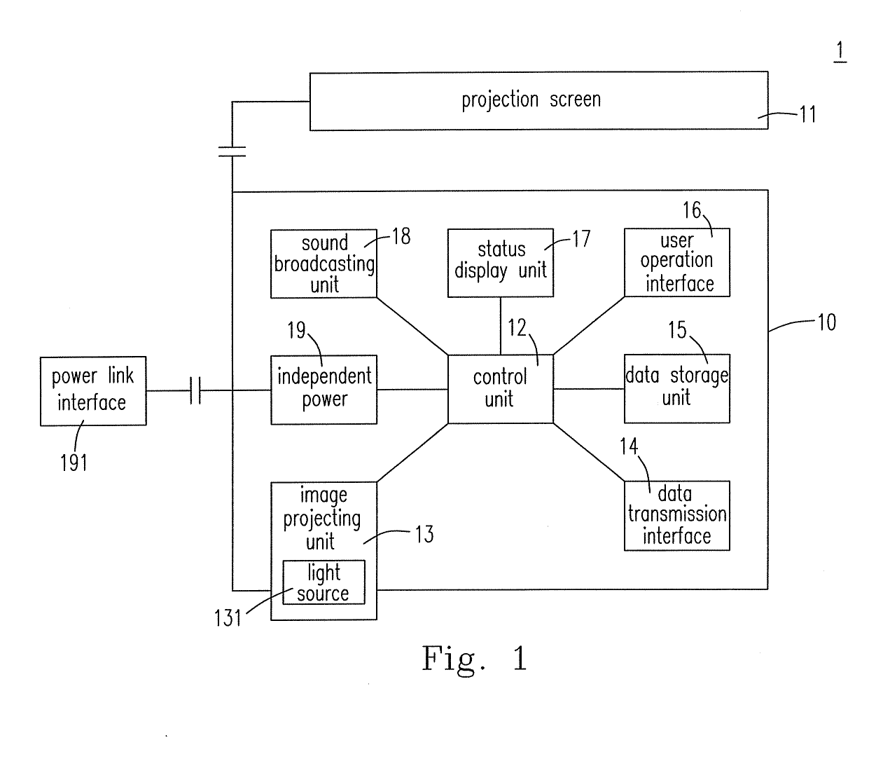

Please refer to FIG. 1, which is a schematic diagram showing the first embodiment for the portable multimedia projection device according to the present invention. As shown in FIG. 1, a portable multimedia projection device 1 includes an image projecting unit 13, a data transmission interface 14, a data storage unit 15, a user operation interface 16, a status display unit 17, a sound broadcasting unit 18, an independent power 19 and a control circuit 12.

The data storage unit 15, such as a hard disk, compact disk (CD), or NVM memory (Flash), is configured to store a multimedia data. The data transmission interface 14 is configured to transfer and/or receive a multimedia data, which could be a wired interface, i.e. USB interface or a wired network interface, or a wireless interface, i.e. IrDA Data/Control interface, Bluetooth interface, a wireless network interface a television antenna, or a CD or tape write/read interface. The data transmission interface 14 can be installed in the data storage unit 15 to be a part thereof.

The image projecting unit 13 is configured to project the image of the multimedia data from the data storage unit 15 and/or the data transmission interface 14, wherein the image projecting unit 13 usually has a light source 131, preferably a light emitting diode (LED) for the purpose of light weighting and power saving.

The independent power 19 is configured to provide the electric power which the portable multimedia projection device 1 requires for operating. The independent power 19 could be a various kind of battery, including a general battery or a secondary cell. A power link interface 191, such as a power line or a plug, is configured to be linked to an exterior power is adoptable for charging the independent power 19 or supporting a long time operation of the device.

The sound broadcasting unit 18, such as a loudspeaker and/or a sound transmission connector, is configured to broadcast sound signals of the multimedia data. The user operation interface 16 is configured for a user inputting a control command thereto. The status display unit 17, such as a LCD monitor and/or a lamp, is configured for displaying the operation status of the portable multimedia projection device. In general, the status display unit 17 can be combined with the operation interface 16 as a part thereof.

The control circuit 12 is electrically connected to the above-mentioned units so as to control the operating, transmitting and broadcasting of the multimedia data.

Base on the above-mentioned disposal, the portable multimedia projection device can project a multimedia image into a light-color background, such as white wall, paper, curtain, and so on.

Preferably, the portable multimedia projection device can be configured with a case 10 and a projection screen 11, wherein the case is configured for housing and protecting at least one of the data storage unit, the image projecting unit, the control circuit and the independent power source, and the projection screen detachably connected to the case for displaying an image projected from the image projecting unit.

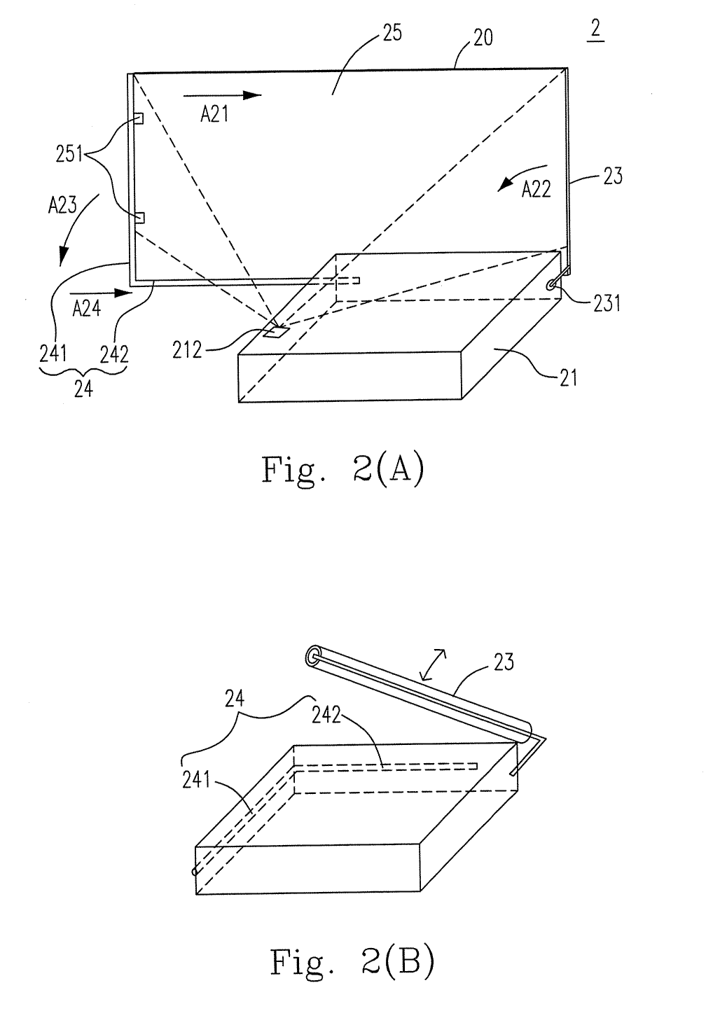

Please refer to FIG. 2(A) and FIG. 2(B), which are schematic diagrams showing the second embodiment for the portable multimedia projection device according to the present invention. As shown in FIG. 2(A) and FIG. 2(B), a portable multimedia projection device 2 includes a main body 21 and a projection screen 20, wherein the main body 21 is disposed with the image projecting unit 212, the data transmission interface, the data storage unit, the user operation interface, the status display unit, the sound broadcasting unit, the independent power, the control circuit and the case, as described in the first embodiment therein. The projection screen 20 includes a curtain 25, a reel 23, an extendable frame 24 and a fastener 251.

The curtain 25 made of a soft material is configured to display an image. The reel 23 is configured to roll up the curtain 25. The extendable frame 24 is capable of extending for supporting the curtain 24. The fastener 251, such as a hook and/or the magnetic elements, is configured to fasten the curtain 25 with the extendable frame 24 while the curtain 25 is opened.

The extendable frame 24 further includes a first stick 241 and a second stick 242, wherein the first stick 241 has the fastener 251 thereon for fastening the curtain 25, and the second stick 242 is connected to the main body 21 and the first stick 241.

When the portable multimedia projection device 2 is operated, the reel 23 and the extendable frame 24 can be expanded as shown in FIG. 2(A) if a light background is unavailable nearby. Then the curtain 25 reeled on the reel 23 is opened and fixed on the extendable frame 24 via the fastener 251, such that an image projected from the image projecting unit 212 can be directly displayed in the curtain 25. The portable multimedia projection device is therefore more useful and limitless in every kind of showing environments.

In order to set the opened curtain 25 close to the projection center, the image projecting unit 212 of the main body 21 can be set nearby the center position in front of the opened curtain 25. For example, the image projecting unit 212 is set in the left side of the main body 21 top in the embodiment.

When the portable multimedia projection device 2 is not operated, the curtain 25 can be reeled on the reel 23 along the direction of arrow A21, thereafter the reel 23 can be rotated along the direction of arrow A22 and fixed closely to the main body 21, while the extendable frame 24 also can be rotated along the direction of arrow A23 and then fixed closely to the main body 21 along the direction of arrow A24, as shown in FIG. 2(B). Accordingly, the device 2 will become more portable and easy to be stored up.

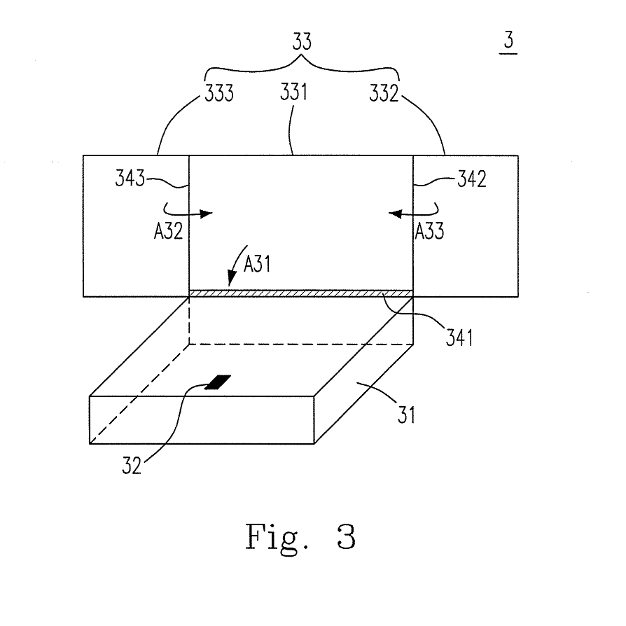

Please refer to FIG. 3, which is a schematic diagram showing the third embodiment for the portable multimedia projection device according to the present invention. As shown in FIG. 3, a portable multimedia projection device 3 includes a main body 31 and a foldable screen 33, wherein the main body 31 is disposed with the image projecting unit 32, the data transmission interface, the data storage unit, the user operation interface, the status display unit, the sound broadcasting unit, the independent power, the control circuit and the case, as described in the first embodiment. The foldable screen 33 includes a first screen 331, a second screen 332 and a third screen 333, wherein the first screen 331 connects with one side of the main body 31 via a first pivot 341, and the second screen 332 and the third screen 333 are rotatably connected to the opposite sides of the first screen 331 via a second pivot 342 and a third pivot 343 respectively.

When the portable multimedia projection device 3 is operated, the first screen 331 can be lifted to stand and fixed in a display angle near vertical, thereafter the second screen 332 and the third screen 333 can be opened and fixed in a position parallel to the first screen 331, hence the first screen 331, the second screen 332 and the third screen 333 are formed as a big plane for displaying a image projected from the image projecting unit 32 from the main body 31.

When the portable multimedia projection device 3 is not operated, or a light background is just available in the showing environment for projecting the images, the foldable screen 33 can be folded and fixed closely to the main body 31 for being easily carried and well arranged.

The folding procedure is turning the second screen 332 toward the first screen 331 along the directions of arrow A32 by the axis of the second pivot 342 until the second screen 332 touches the first screen 331, and turning the third screen 333 toward the first screen 331 along the directions of arrow A33 by the axis of the second pivot 343 until the third screen 333 touches the first screen 331. The pivots 341, 342 and 343 can be provided with the mechanism of a cam or a torque spring having a wedge for fixing in the vertical position for displaying, or fixing closing to the main body 31. Base on the arrangement above mentioned, the image projecting unit 32 can be disposed on the middle of the main body 31 top.

Preferably, the number of the screens in the foldable screen 33 can be varies in accordance with the actual need, and not limited to three screens.

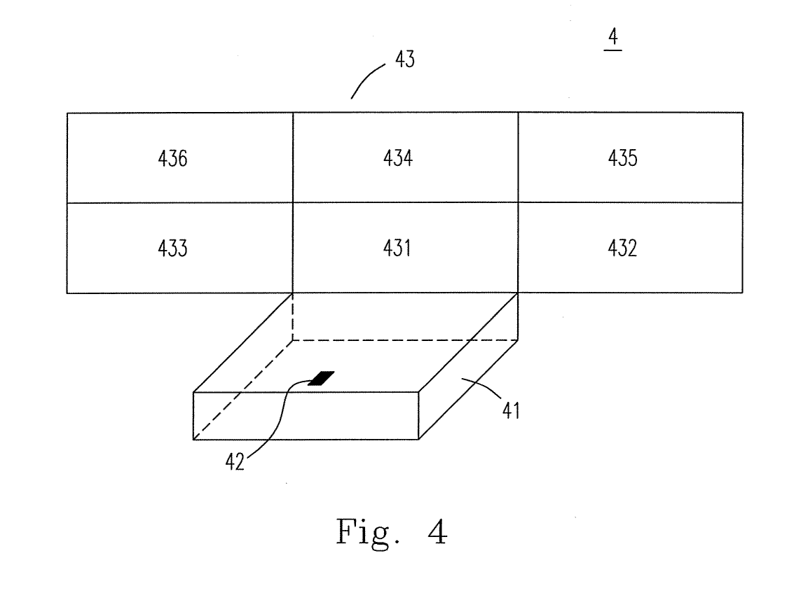

Please refer to FIG. 4, which is a schematic diagram showing the fourth embodiment for the portable multimedia projection device according to the present invention. As shown in FIG. 4, a portable multimedia projection device 4 includes a main body 41 and a foldable screen 43, wherein the foldable screen 43 includes six associated screens symbolized as 431, 432, 433, 434, 435 and 436 respectively. The mechanisms of cams and/or torque springs with wedges can be adopted to fix the associated screens in the projection position or make the associated screens close to the main body 41 for easy-carried.

In sum, the portable multimedia projection device in the present invention is provided with the function of movable display for the multimedia information and data storage, and the advantages of increasing the amount of audience and promoting the sharing quality of the multimedia information, as well as functioning of. Accordingly, the present invention can effectively solve the problems and drawbacks in the prior art, and thus fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A portable multimedia projection device comprising:
a data storage unit storing a multimedia data;
an image projecting unit electrically connected to the data storage unit for projecting the multimedia data;
a control circuit electrically connected to the data storage unit and the image projecting unit for controlling operating, transmitting and broadcasting of the multimedia data;
an independent power source providing an electric power to the portable multimedia projection device, and
a projection screen connected to a case for displaying an image projected from the image projecting unit,
wherein at least one of the data storage unit, the image projecting unit, the control circuit and the independent power source is housed in the case.

2. The portable multimedia projection device according to claim 1, wherein the projection screen further comprises:
a curtain displaying an image;
a reel rolling up the curtain;
an extendable frame supporting the curtain, and
a fastener fastening the curtain with the extendable frame while the curtain is opened.

3. The portable multimedia projection device according to claim 2, wherein the extendable frame further comprises:
a first stick having the fastener thereon for fastening the curtain, and
a second stick connected to the case and the first stick.

4. The portable multimedia projection device according to claim 1 further comprising a sound broadcasting unit having a loudspeaker, wherein the sound broadcasting unit is electrically connected to the control circuit for broadcasting a sound signal of the multimedia data.

5. The portable multimedia projection device according to claim 1, wherein the data storage unit further comprises a data transmission interface for transmitting and receiving a data.

6. The portable multimedia projection device according to claim 5, wherein the data storage unit is one selected from a group consisting of a hard disk, a CD-ROM, a flash memory a memory card and a combination thereof and the data transmission interface is one selected from a group consisting of a USB, a CD-RW reader, a memory card reader an IrDA, a bluetooth, a network interface card an antenna and a combination thereof.

7. The portable multimedia projection device according to claim 1, wherein the image projecting unit has a light source.

8. The portable multimedia projection device according to claim 7, wherein the light source is an LED and the independent power source is a battery.

9. The portable multimedia projection device according to claim 8 further comprising a power link interface, through which an exterior power source provides a electric power to the portable multimedia projection device.

10. The portable multimedia projection device according to claim 1 further comprising a user operation interface electrically connected to the control circuit for inputting a control command to the portable multimedia projection device and displaying an operation status of the portable multimedia projection device.

11. A portable multimedia projection device comprising:
a data storage unit storing a multimedia data;
an image projecting unit electrically connected to the data storage unit for projecting the multimedia data;
a control circuit electrically connected to the data storage unit and the image projecting unit for controlling operating, transmitting and broadcasting of the multimedia data, and
an independent power source providing an electric power to the portable multimedia projection device.

12. The portable multimedia projection device according to claim 11 further comprising:
a case housing at least one of the data storage unit, the image projecting unit, the control circuit and the independent power source, and
a projection screen detachably connected to the case for displaying an image projected from the image projecting unit.

13. The portable multimedia projection device according to claim 12, wherein the projection screen further comprises a first screen connected with the case via a first pivot, and the first screen rotates with the first pivot.

14. The portable multimedia projection device according to claim 13, wherein the projection screen further comprises at least one second screen connected with the first screen via a second pivot, and the second screen is able of being opened and folded in a specific angle.

15. A portable multimedia projection device comprising:
a data transmission interface transferring a multimedia data;
an image projecting unit electrically connected to the data transmission interface and provided with a light for projecting an image of the multimedia data, and
an independent power source providing the electric power to the portable multimedia projection device.

16. The portable multimedia projection device according to claim 15 further comprising:
a case, and
a projection screen detachably connected with the case for displaying the image projected from the image projecting unit,
wherein at least one of the data storage unit, the image projecting unit, the projection screen and the independent power source is contained in the case.

17. The portable multimedia projection device according to claim 16, wherein the projection screen further comprises:
a curtain displaying an image;
a reel for rolling up the curtain, and
an extendable frame connected with the case for supporting the curtain,
wherein the extendable frame further comprising
a first brace connected with the case and the reel for supporting the reel, and
a second brace having a plurality of linkages for supporting the curtain.

18. The portable multimedia projection device according to claim 16, wherein the projection screen further comprises a first screen connected with the case via a first pivot, and the first screen rotates with the first pivot.

19. The portable multimedia projection device according to claim 18, wherein the projection screen further comprises at least one second screen connected with the first screen via a second pivot, and the second screen is capable of being opened and folded in a specific angle.

20. The portable multimedia projection device according to claim 16 further comprises:
a data storage unit electrically connected to the data transmission interface for storing the multimedia data;
a sound broadcasting unit electrically connected to the data transmission interface for broadcasting a sound signal of the multimedia data;
a user operation interface for inputting a control command to the portable multimedia projection device and displaying an operation status of the portable multimedia projection device, and
a control circuit electrically connected to the data transmission interface, the data storage unit, the image projecting unit, the sound broadcasting unit and the user operation interface so as to control operating, transmitting and broadcasting of the multimedia data.
